(19) United States
(12) Patent Application Publication
(10) Pub. No.: US 2024/0118384 A1
(43) Pub. Date: Apr. 11, 2024

(54) METHOD FOR EVALUATING A PLURALITY OF RECEIVED SIGNALS

(71) Applicant: MEYSENS GMBH, Munich (DE)

(72) Inventors: Alexander RUDOY, Munich (DE); Christian WELK, Munich (DE); Michele CORONA, Munich (DE)

(21) Appl. No.: 18/572,541

(22) PCT Filed: Jun. 29, 2022
(86) PCT No.: PCT/EP2022/067949

§ 371 Date: Dec. 20, 2023

(30) Foreign Application Priority Data
Jun. 29, 2021 (LU) LU500347

(51) Int. Cl. G01S 7/292; G01S 7/35; G01S 7/536; G01S 7/54; G01S 13/36; G01S 13/87; G01S 15/36; G01S 15/87

(52) U.S. Cl. CPC G01S 7/2921; G01S 7/354; G01S 7/536; G01S 7/54; G01S 13/36; G01S 13/878; G01S 15/36; G01S 15/876

(57) ABSTRACT

The invention relates to a method for evaluating multiple received signals (6, 8, 11), wherein the method has the following steps:
sending a transmission signal (3)
receiving a first signal (6), which contains the transmission signal via a first receiver (5) and
receiving a second signal (8), which contains the transmission signal via a second receiver (7), characterized in that
to evaluate the received signals (6, 8), the received signals (6, 8) are compared with one another, wherein the comparison comprises determination of a time difference and/or phase difference between the first signal (6) and the second signal (8).

The invention relates to a method for evaluating multiple received signals. In addition, the invention relates to the use of such a method in three-dimensional position determination and a device with at least one transmitter, a first receiver and a second receiver.

Sensors are known from the prior art which have a transmitter that actively emits an ultrasonic wave and detects reflections from various objects that are in the field of view of the sensor by means of at least one receiver. In addition to reflecting the actively generated sound wave, the sensor also picks up ambient noise and other types of noise. The received signals may originate from a reflection and/or may be distorted by interference.

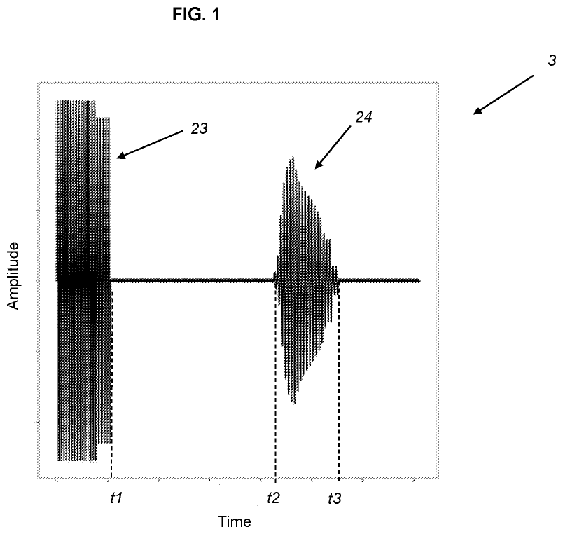

FIG. 1 shows a section of a signal 3 received by a receiver. In particular, FIG. 1 shows the amplitude curve of the received signal 3 over time, wherein the vertical axis represents the amplitude and the horizontal axis represents the time. A first signal region 23 up to the first time t1 represents the emitted sound wave, which is recorded directly between the transmitter and receiver. A second signal region 24 recorded between a second time t2 and a third time t3 represents an interesting section of the received signal 3. The remaining portions of the received signal can be considered noise. The interesting section could be the reflection of the actively emitted sound wave or some other loud noise. It is therefore necessary to determine whether this section is a reflected transmission signal or interference noise.

In known methods it is assumed that the actively emitted sound wave corresponds to the section of the received signal whose amplitude is greater than a predetermined threshold value. However, such a method has the disadvantage that it is inaccurate, in particular as loud ambient noises, i.e. noises with high amplitude, are incorrectly recorded as a reflected transmission signal. A problem also exists in that the transmitted signal can interfere with other signals on its way between the transmitter and receiver. In such a case, the transmission signal contained in the received signal cannot then be recognized or is of poor quality. For example, with a signal of poor quality, signal processing can deliver inaccurate or incorrect measured values. In both cases, the received signal cannot be processed further.

The object of the invention is therefore to provide a method by means of which received signals can be evaluated, in particular with regard to their quality and/or reliability.

The object is achieved by a method for evaluating multiple received signals, wherein the method has the following steps:
sending a transmission signal,
receiving a first signal containing at least part of the transmission signal via a first receiver and
receiving a second signal, which contains at least part of the transmission signal via a second receiver, characterized in that
to evaluate the received signals, the received signals are compared with one another, wherein the comparison comprises determination of a time difference and/or phase difference between the first signal and the second signal.

A further object of the invention is to provide a device by means of which the received signals can be evaluated.

The object is achieved by a device, having at least one transmitter for sending a transmission signal, a first receiver for receiving a first signal which contains at least part of the transmission signal, a second receiver for receiving a second signal which contains at least part of the transmission signal, characterized in that the device has an evaluation device which compares the received signals with one another to evaluate the received signals, wherein the comparison comprises a determination of a time difference and/or phase difference between the first signal and the second signal.

According to the invention, it was recognized that a time difference and/or phase difference between the first signal received by the first receiver and the second signal received by the second receiver is not constant or essentially constant all the time, but only in certain time periods.

Therefore, these time periods can be used to evaluate the signals. It was thus recognized that the quality of the received signals can be evaluated if at least two received signals are compared with one another. As will be explained in more detail below, a statement can be made about the quality of the received signals in the time period under consideration by considering the phase angle difference and/or time difference relative to a threshold value.

The quality of the transmission signal contained in the received signal is usually higher the more similar the transmission signal is to the transmission signal emitted by the transmitter. In the ideal state, the transmission signal contained in the received signal corresponds to the emitted transmission signal and therefore has the highest quality. The method according to the invention checks whether the received signals have a similar phase response. If this is the case, the received signal or signal section is rated as high quality and therefore reliable.

In addition, it was recognized that the time difference and/or phase difference is constant or essentially constant only in the time period in which the transmission signal is recorded and in which the transmission signal is not changed due to interference in such a way that it can no longer be recognized or is very likely to lead to incorrect measured values. In this respect, the evaluation of this time period means that it can be determined whether the signal recorded in the time period can be further processed. Consequently, with the method according to the invention it is not necessary for the entire signal to be evaluated. This leads to faster signal processing.

It is irrelevant whether the first and/or second receiver receives the transmission signal directly, i.e. a non-reflected transmission signal, or a reflected transmission signal. The received signals can be time-delayed from one another. Since the distance between the receivers is at most, in particular less than, half a wavelength of the received signal and/or the maximum frequency of the transmitted signal or the received signal, this ensures that the received signals overlap. This is the case if the receivers receive the signals at different times due to their arrangement relative to one another.

Another advantage to the method is that it is quick. In this respect, the method can be used in addition to already known methods in which a signal section of the received signal and thus a time range of the received signal which contains the transmitted signal is determined. As a result, carrying out the method according to the invention increases the accuracy of determining the section of interest in the received signal, i.e. the section that contains the transmitted signal. This arises because the method according to the invention functions in this case as an additional check as to whether the time period determined using a known method is actually relevant, i.e. contains at least part of the transmission signal. In addition, the method can also be used to evaluate whether the transmission signal determined in the time range is of good quality. The known method can be the method described above, in which the amplitude level of the received signal is used to determine the transmitted signal. The time range can correspond to the time period or be longer than the time period.

The transmission signal can be a wave, in particular an electromagnetic wave, or a pressure wave, in particular a sound wave. The received signal can be a wave, in particular an electromagnetic wave, or a pressure wave, in particular a sound wave. The evaluation device can be a processor or have at least one processor.

The transmitter can emit the transmission signal in all spatial directions or at least in a half-space. In particular, the transmitter can be a sound transmitter. In addition, the transmitter can have at least one piezo component by means of which the transmission signal can be generated. The receiver is designed to receive the transmission signals emitted by the transmitter, in particular the transmission signals that are at least partially reflected by the object.

In a particular embodiment, the transmitter can be controlled to generate the transmission signal using a predetermined number of control signals. Alternatively or additionally, the transmission signal can be output for a predetermined time period. The transmission signal is therefore not received continuously via the receiver or receivers, in particular not during the entire receiving process. The predetermined time period during which the transmission signal is output is less than the time period during which the receivers receive signals. The transmitter can be controlled in such a way that the transmitted signal output has a sinusoidal curve. Alternatively, the transmission signal can have a rectangular shape.

The control signal can be a modulated signal. This is possible because only the received signals are compared with one another and the process therefore works. With a modulated signal, the transmission time can also be determined with a continuous signal, even if it is generated by another transmitter.

The transmission signal can be at least partially reflected by an object. The receivers can receive the at least partially reflected transmission signal. In addition, the transmission signal can be transmitted directly to at least one receiver. In addition, the transmission signal can be received via at least one receiver without reflection, i.e. without the transmission signal being reflected by an object. The evaluation device therefore knows the time at which the transmission signal is sent. The transmission of the transmission signal directly to the at least one receiver can take place each time the transmission signal is output by the transmitter. Alternatively, the transmission signal can be transmitted to the receiver at specific times. However, the time at which the transmission signal is emitted is irrelevant for evaluating the received signals. As already described above, the quality is assessed depending on the time difference and/or phase difference of the first and second received signals. The time difference and/or phase angle difference can be determined independently of the transmission time. As will be explained in more detail below, the method also works with more than two receivers and/or with more than two received signals.

A method in which the transmission signal is a non-modulated transmission signal, in particular is not modulated by the control signal, is particularly advantageous. Likewise, the received signal cannot be modulated. In particular, there is no frequency and/or amplitude modulation of the transmitted signal and/or the received signal. The method is therefore suitable for evaluating the quality of modulated and unmodulated received transmission signals without having to carry out time-consuming calculations in the evaluation device.

The device can have a housing, wherein the evaluation device can be arranged in an interior of the housing. At least one receiver, in particular at least two receivers, and the transmitter can be mechanically connected to the housing. The evaluation device can carry out the necessary method steps for evaluating the received signals.

The method can be carried out in a predetermined time range of the received signals. The predetermined time range can be determined by another, in particular known, method and indicates the time range of the received signals that contain at least part of the transmission signal. The other method may be the method described above, in which the transmitted signal is determined in the received signal based on the amplitude height. This offers the advantage that the method according to the invention no longer has to be carried out over the entire recorded period, which means that the method is carried out more quickly. The received signals are evaluated for their quality within the predetermined time range. In particular, the received signals are evaluated to establish whether the quality of the transmission signal recorded in the predetermined time range is sufficiently high. If this is the case, the transmission signal recorded in the predetermined time range can be further processed. In particular, a position, in particular three-dimensional position, of an object and/or a distance, in particular trilateration/angulation, between the object and the device can be determined using the transmission signal recorded in the predetermined time range.

A signal section of the first received signal and another signal section of the second received signal, which are compared with one another to evaluate the received signals, may have the same phase angle range. If a third signal is received via a third receiver, another signal section of the third signal, which is compared with the signal section of the first signal and/or the further signal section of the second signal, can have the same phase angle range as the signal section of the first signal and the further signal section of the second signal. The phase angle refers to the respective signal and not to an absolute phase angle. This occurs because the receivers do not receive the signals at the same time, but with a time delay. As a result, identical signal sections of the received signals should be compared with one another.

In a particular embodiment, the received first signal can be divided into several signal sections. The signal sections of the first signal can have the same phase angle range. The phase angle range can be 90°, 180° or 360°. However, other phase angle ranges are also possible. The individual signal sections are arranged offset from one another, particularly in terms of time.

The evaluation device can determine a curve function of the signal section. In particular, the evaluation device can determine the course of each signal section. The course of the signal section can be determined by at least one algorithm. The determination can also comprise fitting. As already described above, the transmission signal can have a sinusoidal curve. This makes it particularly easy to determine the course of the signal section.

The evaluation device can determine one or more signal points in the signal section. In particular, the evaluation device can determine one or more signal points in each signal section. The signal points can be determined in a simple manner if, as described above, the curve function of the signal section is determined.

In addition, the evaluation device can determine a time and/or phase angle assigned to the signal point. When determining several signal points, the evaluation device can determine the time and/or phase angle assigned to the signal point for each signal point. This makes it easy to know at what time the respective signal point is present.

The signal points of the first signal can be arranged offset from one another, in particular by a predetermined phase angle. Alternatively or additionally, the at least two signal points can each be arranged offset from a reference point by a predetermined phase angle. In addition, the signal points are arranged offset from one another in terms of time.

The signal point can be a point that characterizes the course of the signal section. The signal point can be a maximum, a minimum, a zero crossing or a turning point of the signal section. Alternatively or additionally, a signal point can be any point of the signal section with a predetermined phase angle or a predetermined phase angle difference to another signal point or a reference point.

In a particular embodiment, the received second signal can be divided into several further signal sections. The further signal sections of the second signal can have the same phase angle range. The phase angle range can be 90°, 180° or 360°. However, other phase angle ranges are also possible. The individual further signal sections are arranged offset from one another, in particular in terms of time.

The evaluation device can determine a curve function of the further signal section, in particular of each further signal section. In particular, the evaluation device can determine the course of each additional signal section. The course of the further signal section can be determined by at least one algorithm. As already described above, the transmission signal can have a sinusoidal curve. This makes it particularly easy to determine the course of the further signal section.

The evaluation device can determine one or more further signal points in the further signal section. In particular, the evaluation device can determine one or more further signal points in each further signal section. The determination of the further signal points is possible in a simple manner if, as described above, the curve function of the further signal section is known.

In addition, the evaluation device can determine a further time and/or a further phase angle assigned to the further signal point. When determining several further signal points, the evaluation device can determine the further time and/or further phase angle assigned to the further signal point for each further signal point. This makes it easy to know at which further time and/or further phase angle the respective further signal point is present.

The number of determined further signal points can correspond to the number of determined signal points. This allows an offset characteristic curve, explained in more detail below, to be determined in a simple manner.

The further signal points of the second signal can be arranged offset from one another, in particular by a predetermined phase angle. Alternatively or additionally, the at least two further signal points can each be arranged offset from a reference point by a predetermined phase angle. In addition, the further signal points are arranged offset from one another in terms of time.

The evaluation device can assign a further signal point to each signal point. The assignment can be carried out in such a way that the assigned further signal point in the further signal section has the same phase angle as the signal point in the first signal section or that the assigned further signal point in the further signal section is arranged offset from the signal point in the signal section by a predetermined phase angle.

In a particular embodiment, at least one offset characteristic value can be determined, which depends on a time difference and/or phase angle difference between the first signal and the second signal. In particular, the times assigned thereto can be determined for the signal points and the further times assigned thereto can be determined for the further signal points, and the offset characteristic value can be determined by determining a time difference between a pair of signal points. The time difference for a pair of signal points corresponds to a difference between the time assigned to the signal point and the further time assigned to the further signal point. Likewise, the offset characteristic value can be determined by determining a phase angle difference of a pair of signal points. The phase angle difference for a pair of signal points corresponds to a difference between the phase angle assigned to the signal point and the further phase angle assigned to the further signal point. When determining several offset characteristic values, an offset characteristic curve can be generated.

The determination of the offset characteristic value is carried out in such a way that the time difference and/or phase angle difference of several pairs of signal points is determined. A first pair of signal points can have a first signal point and a first further signal point and a second pair of signal points can have a second signal point and a second further signal point. The first signal point can be adjacent to the second signal point and the first further signal point can be adjacent to the second further signal point. Adjacent is understood to mean that the two signal points are offset from one another in time and/or phase angle and there are no further signal points between the two signal points.

In one embodiment, it can be checked whether the at least one offset characteristic value lies within a predetermined range. In particular, it can be checked whether a large number of offset characteristic values lie within the predetermined range. The predetermined range is limited by an upper and a lower limit. The evaluation device can determine a time period in which the offset characteristic value or the offset characteristic values are located in the predetermined range. The evaluation device can evaluate the received signals depending on the result of the check. The evaluation device can determine that the quality of the first signal and the second signal is good in a time period of the first signal and the second signal in which the offset characteristic value is in the predetermined range and/or if several offset characteristic values for a predetermined time period are within the within the predetermined range. The predetermined time period can be a control period of the transmitter with the control signal or can depend on it.

This test makes use of the knowledge that the time difference and/or phase angle difference between the received signals is constant or essentially constant in the time period in which the received signals contain the transmitted signal. This arises because the course of the transmission signal is essentially the same in both the first received signal and the second received signal. A time period of the first and second received signals can then be determined in which the offset characteristic values lie in the predetermined range, i.e. have an essentially constant value.

A more precise evaluation of the first and second received signals can be carried out if a large number of offset characteristic values are determined and groups are formed, each of which has several offset characteristic values. The groups can be adjacent to one another. In addition, the groups can have the same time period and/or have the same number of offset characteristic values.

For each of the groups, a difference between a maximum value of the offset characteristic values and a minimum value of the offset characteristic values can be determined. The time period can depend on at least one difference value between a maximum value and a minimum value of the offset characteristic values in a time range. Alternatively or additionally, a variance of the offset characteristic values can be determined. The time period can depend on the variance values. At least one variance value can be determined for each of the groups. Variance is understood as the spread of a number of values around their mean.

The evaluation of the received signals can, as explained above, depend on the difference value and/or variance value and the predetermined threshold value. In particular, the evaluation can depend on whether the difference value is larger or smaller than the threshold value. When assessing the received signals, the evaluation device can check whether the at least one difference value is smaller than a predetermined threshold value and is therefore below the threshold value. In addition, the evaluation device checks whether the time period, during which the difference values are smaller than the predetermined threshold value, is no longer or not significantly longer than a predetermined time period. In the event that the time period for which the difference values are below the predetermined threshold value is longer or is significantly longer than a predetermined time period, there is an external signal that should not be further processed.

Alternatively or additionally, the evaluation device can determine a time period in which the variance values are smaller than a predetermined threshold value, i.e. are below the threshold value. In addition, the evaluation device can check whether the time period, during which the variance values are below the predetermined threshold value, is no longer or not significantly longer than a predetermined time period. In the event that the time period for which the variance values are below the predetermined threshold value is longer or significantly longer than a predetermined time period, there is an external signal that should not be further processed.

The predetermined time period can be a control period of the transmitter with the control signal or can depend on it. Thus, the time period during which the difference values and/or variance values are smaller than the threshold value cannot be longer or not significantly longer than the control period. A difference value characteristic curve and/or the variance values can be formed by determining the difference value characteristic curve. This embodiment takes advantage of the fact that in the time period of the first and second signals in which the transmission signal is arranged, there is little difference between the maximum and minimum values of the offset characteristics and/or the variance. Therefore, by specifying a corresponding small threshold value, a signal section of the first and second signals that is of a high quality can be determined.

In a particular embodiment, the device can have a third receiver, which receives a third signal which contains at least part of the transmission signal and can be phase-offset in relation to the first signal and the second signal. The provision of three receivers enables a position of the object in three-dimensional space to be determined. In particular, a vector for the reflection object and, if the transmission time and/or the sound flight time is known, the position of this object in three-dimensional space can be determined.

The evaluation device can determine at least one further offset characteristic value, which depends on a time difference between the first signal and the third signal. In addition, the evaluation device can form at least one other offset characteristic value, which depends on a time difference between the second signal and the third signal. The determination of the further offset characteristic value and the other offset characteristic value can be carried out in a similar manner to the determination of the offset characteristic value.

Several further offset characteristics can be determined, wherein groups are formed which have several further offset characteristics. In each of the groups, the difference between a maximum value of the further offset characteristic value and a minimum value of the further offset characteristic value is formed. The evaluation device then determines a further time period in which the difference values are below the predetermined threshold value. Alternatively or additionally, a variance of the further offset characteristic values can be determined. At least one variance value can be determined for each of the groups. The evaluation device can determine a further time period in which the offset characteristic values are below the predetermined threshold value.

In addition, the evaluation device can determine whether the offset characteristic values are no longer or not significantly longer than the predetermined time period below the predetermined threshold value. In other words, it is checked whether the further time period corresponds at most or substantially to the predetermined time period. Here the specified time period is the predetermined time period mentioned above.

In addition, the evaluation device can determine several other offset characteristic values, wherein groups that have several other offset characteristic values are formed. In each group, the difference between a maximum value of the other offset characteristic value and a minimum value of the other offset characteristic value can be formed. The evaluation device can determine another time period in which the difference is below the predetermined threshold value. Alternatively or additionally, a variance of the offset characteristic values can be determined. At least one variance value can be determined for each of the groups. The evaluation device can determine a further time period in which the offset characteristic values are below the predetermined threshold value. In addition, the evaluation device can determine whether the offset characteristic values are no longer or not significantly longer than a predetermined time period below the predetermined threshold value. In other words, it is checked whether the other time period corresponds at most or essentially to the predetermined time period.

In the event that the time period and the further time period, in particular and the further time period, correspond to the predetermined time period or are no longer than the predetermined time period, the evaluation device can determine an overlap time period in which the time period corresponds to the further time period and/or with overlaps with the other time period. In the event that the time period and/or the further time period and/or the other time period is longer than the predetermined time period, it is determined that it is an external signal and no overlap period is determined. The evaluation device can determine that in this overlap time period the received signals contain the transmission signal and therefore the quality in this time period is good. In the remaining signal section or time period of the received signals, the quality is considered to be insufficient.

The evaluation device can check whether the overlap time period corresponds to a predetermined lower time period or is longer than the predetermined lower time period. If this condition is not met, the signal is not processed further. Unless an overlap section can be determined, the signals received via the receivers do not come from the same source.

The signal part of the respective signal located in the overlap time period can be further processed in order, for example, to determine a position of the object and/or a distance between the object and the device.

The signal section of the received signal located in the overlap time period can be used to determine the position of an object, in particular for one-dimensional, two-dimensional or three-dimensional position determination. Furthermore, the signal sections of the received signals located in the overlap time period can also be used to determine the, in particular three-dimensional, position of an object.

The distance between the receivers can be at most half a wavelength of the received signal and/or the highest frequency of the transmitted signal or the received signal. Preferably, the distance between the receivers can be less than half a wavelength of the received signal.

For determining a three-dimensional position, the transmitter and one receiver or two receivers can be arranged in a straight line. The third receiver is arranged in such a way that it is not arranged in a straight line. The transmitter and all receivers lie in a plane that has the straight line. The object is arranged such that it is spaced at a distance from the plane. In other words, the object is not located on the plane. The transmitter can act as one of the receivers after sending out the transmission signal. This means that the transmitter can send the transmit signal as well as receive signals.

It is particularly advantageous if the method according to the invention is used in three-dimensional position determination, in particular by means of the device described above.

The subject matter of the invention is shown schematically in the figures, wherein elements that are the same or have the same effect are usually provided with the same reference symbols. In the figures:

FIG. 1 shows a course of a received signal,

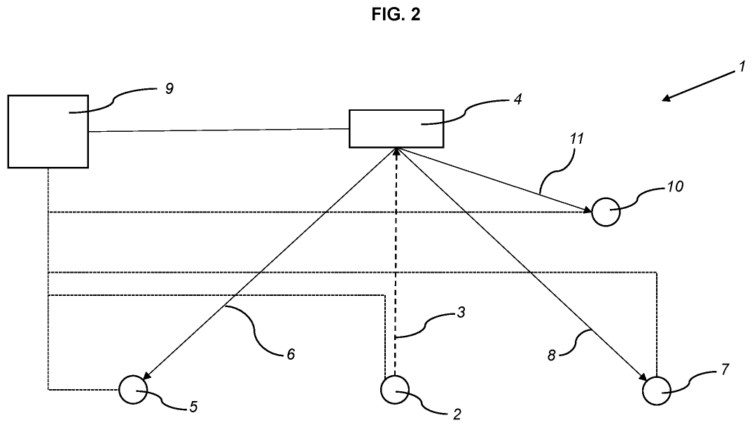

FIG. 2 shows a device for determining a transmission signal in the received signal shown in FIG. 1,

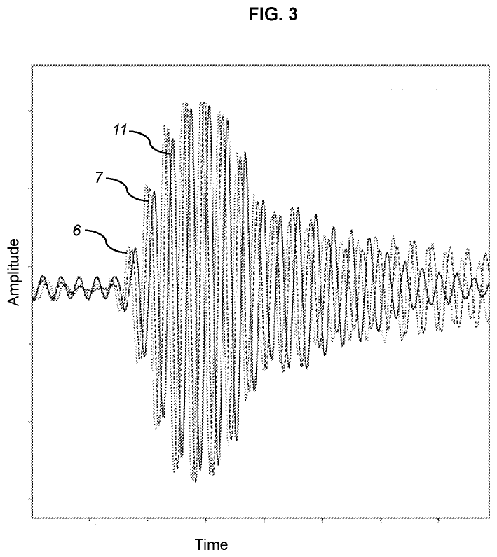

FIG. 3 shows part of the signals received via a first, second and third receiver of the device,

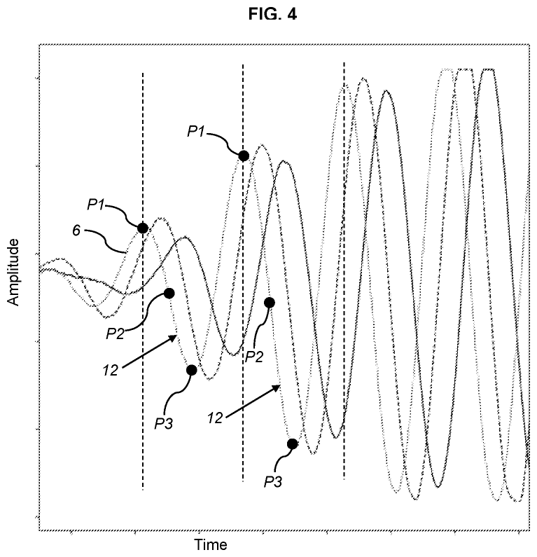

FIG. 4 shows an enlarged section of the signal curves shown in FIG. 3 wherein the signal points of the signal sections are shown,

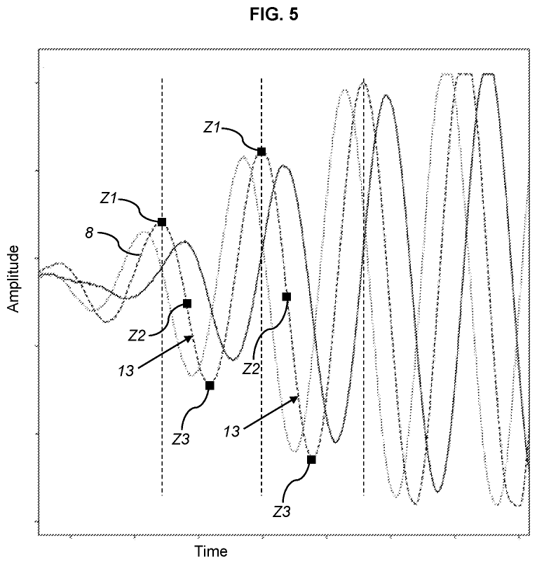

FIG. 5 shows an enlarged section of the signal curves shown in FIG. 3, wherein the further signal points of the further signal sections are shown,

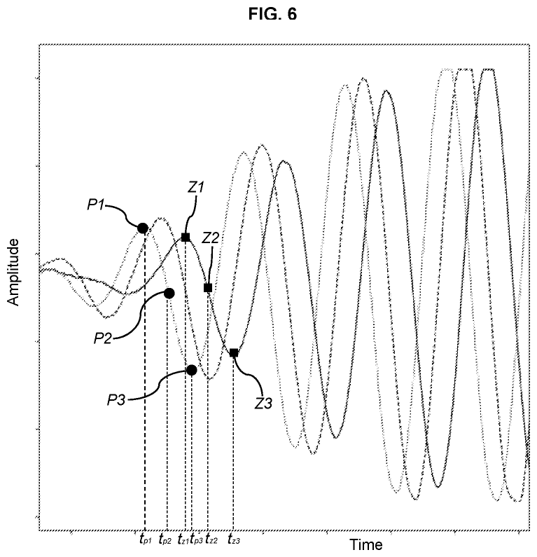

FIG. 6 shows an enlarged section of the signal curves shown in FIG. 3 with first and second signal points,

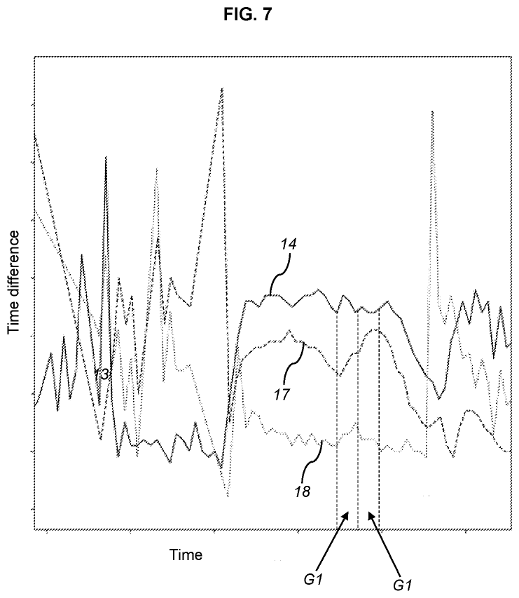

FIG. 7 shows a course of several offset characteristic curves,

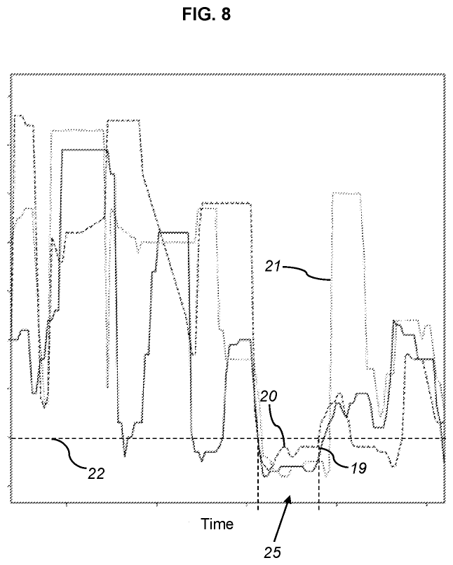

FIG. 8 shows a course of several difference value characteristic curves, and

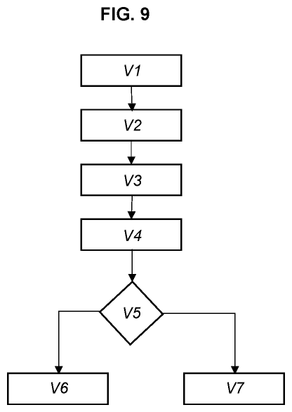

FIG. 9 shows a flowchart for determining the transmission signal in the received signal.

A device 1 shown in FIG. 2 for determining a transmission signal 3 in a received signal 6, 8, 11 has a transmitter 2 and three receivers 5, 7, 10, namely a first receiver 5, a second receiver 7 and a third receiver 10. In addition, the device 1 has an evaluation device 9, which is connected in terms of data technology to the transmitter 2 and each of the receivers 5, 7, 10. The data connection is shown in dashed lines in FIG. 2.

The transmitter 2 sends a transmission signal 3 to the environment. The transmission signal 3 is reflected on an object 4 that does not form part of the device 1. The first receiver 5 receives a first signal 6, the second receiver 7 receives a second signal 8 and the third receiver 10 receives a third signal 1. Each of the signals 6, 8, 11 received in FIG. 2 contains the reflected part of the transmission signal 1. However, the received signals also contain noise, such as ambient noise, which do not originate from the object 4. The transmitter 2 also sends a transmission signal 3 directly to the first receiver 5. This means that this transmission signal 3 is not reflected by the object 4.

FIG. 3 shows part of the signals 6, 8, 11 received via a first, second and third receiver 5, 6, 10 of the device 1. From FIG. 3 it can be seen that the individual signals detected are time-delayed from one another. This results from the fact that the receivers 5, 6, 10 receive at different times.

FIG. 4 shows an enlarged section of the signal curves shown in FIG. 3, wherein the signal points P1, P2, P3 of the signal sections 12 are shown. From FIG. 4 it can be seen that the first signal 6 is divided into several signal sections 12. The signal sections 12 have a phase angle range of 360°, wherein the boundaries of the signal sections 12 in FIG. 4 are symbolized by vertical dashed lines. In FIG. 4, two signal sections 12 of the first signal 6 are explicitly shown, but the entire first signal 4 can be divided into several signal sections 12.

The evaluation device 9 determines a curve function for each of the signal sections 12. In addition, the evaluation device 9 determines multiple signal points P1, P2, P3 in each of the signal sections 12. In the embodiment shown in FIG. 4, three signal points P1, P2, P3 are determined, namely a first signal point P1, a second signal point P2 and a third signal point P3. The first signal point P1 corresponds to the maximum of the signal section 12, the second signal point P2 corresponds to a turning point of the signal section 12 and the third signal point P3 corresponds to a minimum of the signal section 12. The first three signal points P1, P2, P3 have different phase angles.

The first signal point P1 12 is arranged in the signal section adjacent to the second signal point P2 in the signal section 12. The second signal point P2 is additionally arranged adjacent to the third signal point P3 in the signal section 12. The third signal point P3 is then additionally arranged adjacent to a first signal point P1 of an adjacent signal section 12.

The evaluation device 9 determines the associated time tp1-tp3 for each determined signal point P1, P2, P3. In this respect, the evaluation device 9 is given the known times tp1-tp3 at which the signal points P1, P2, P3 are present. Alternatively or in addition to determining the time, a phase angle determination is possible. However, the method described below uses only the time determination. The method can be carried out in an analogous manner if the phase angle difference is determined.

FIG. 5 shows an enlarged section of the signal curves shown in FIG. 3, wherein the further signal points Z1, Z2, Z3 of the further signal sections 13 are shown. From FIG. 5 it can be seen that the second signal 8 is divided into several further signal sections 13. The further signal sections 13 have a phase angle range of 360°, wherein the boundaries of the further signal sections 13 are symbolized in FIG. 5 by vertical dashed lines. Three further signal sections 13 of the second signal 8 are explicitly shown in FIG. 5, but the entire second signal 8 can be divided into further signal sections 13.

The evaluation device 9 determines a curve function for each of the further signal sections 13. In addition, the evaluation device 9 determines several further signal points Z1, Z2, Z3 in each of the further signal sections 13. In the embodiment shown in FIG. 5, three further signal points Z1, Z2, Z3 are determined, namely a further first signal point Z1, a further second signal point Z2 and a further third signal point Z3. The further first signal point Z1 corresponds to the maximum of the further signal section 13, the further second signal point Z2 corresponds to a turning point of the further signal section 13 and the further third signal point Z3 corresponds to a minimum of the further signal section 13. The three other signal points Z1, Z2, Z3 have different phase angles.

The first signal point Z1 is arranged in a signal section 13 adjacent to the second signal point Z2 in the signal section. The second signal point Z2 is additionally arranged adjacent to the third signal point Z3 in the signal section 13. The third signal point Z3 is then additionally arranged adjacent to a first signal point Z1 of an adjacent signal section 13.

The evaluation device 9 determines the associated time tz1-tz3 for each determined second signal point Z1, Z2, Z3. In this respect, the times tz1-tz3 for which the further signal points Z1, Z2, Z3 are available are known by the evaluation device 9.

FIG. 6 shows an enlarged section of the signal curves shown in FIG. 3, wherein the signal points P1, P2, P3 and the further signal points Z1, Z2, Z3 are shown. The evaluation device 9 determines a time difference between pairs of signal points. Pairs of signal points are formed by signal points P1, P2, P3 of the first signal 6 and further signal points Z1, Z2, Z3 of the second signal 8. The signal point P1, P2, P3 of the first signal 6 has the same phase angle as the further signal point Z1, Z2, Z3 of the second signal 8.

Three pairs of signal points are shown in FIG. 6. A first pair of signal points is formed by the first signal point P1 and the further first signal point Z1. A second pair of signal points is formed by the second signal point P2 and the further second signal point Z2. A third pair of signal points is formed by the third signal point P3 and the further third signal point Z3.

A time difference is determined for each pair of signal points. In particular, the time difference between points in time assigned to the signal points is determined. For the first pair of signal points, the time difference between the time tp1 assigned to the first signal point P1 and the time tz1 assigned to the further first signal point Z1 is determined. The same calculation is repeated for the remaining two pairs of signal points. As a result, offset characteristic values are determined by forming the difference.

FIG. 7 shows a course of several offset characteristic curves 14, 17, 18. The vertical axis represents the time difference and the horizontal axis represents the time. The offset characteristic curve 14 results from a large number of offset characteristic values, which result from the above-described determination of the time difference between the signal points of the first signal 6 and the second signal 8.

FIG. 7 shows a further offset characteristic curve 17, which results from a large number of further offset characteristic values. The further offset characteristic values result from determining the time difference between the signal points of the first signal 6 and the third signal 11. In addition, another offset characteristic curve 18 is shown in FIG. 7, which results from a large number of other offset characteristic values. The other offset characteristic values result from determining the time difference between signal points of the second signal 8 and the third signal 11. The further offset characteristic curve 17 and the other offset characteristic curve 18 are determined in a similar manner to the offset characteristic curve 14.

Groups G1 are formed which have several offset characteristic values. Only two groups G1 are shown in FIG. 7. However, all offset characteristic values are grouped into groups G1. The offset characteristic curves 14, 17, 18 are each entirely divided into groups. The individual groups share the same time period and/or the same number of offset characteristic values. In each of the groups G1, a difference is formed between the maximum value in the time range and the minimum value of the offset characteristic value. This procedure takes place for each of the offset characteristic curves 14, 17, 18. Alternatively or additionally, a variance of the offset characteristic values is determined for each group Cl. At least one variance value is thus determined for each group Cl.

The result is three difference value characteristic curves that are based on the difference values determined and are shown in FIG. 8. A first difference value characteristic curve 19 is assigned to the offset characteristic curve 14. A second difference value characteristic curve 20 is assigned to the other offset characteristic curve 18 and a third difference value characteristic curve 21 is assigned to the further offset characteristic curve 17. Instead of the difference value characteristic curves, variance value characteristic curves can be determined. The method according to the invention works analogously if the above-mentioned variance values are used instead of difference values.

From FIG. 8 it can be seen that in the overlap time period 25, which is delimited by the vertical dashed lines, all three difference value characteristic curves 19, 20, 21, no longer than a predetermined time period, are below a threshold value 22. In other words, the difference values and or variance values of the respective difference value characteristic curve 19, 20, 21 have difference values in the time period that are below the threshold value, i.e. are smaller than the threshold value. The evaluation device 9 identifies this section as the overlap time period. Likewise, variance value characteristics, not shown, in the transmission signal time period have variance values that are below the threshold value.

In addition, the evaluation device 9 determines that the first signal, the second signal and the third signal in the overlap time period are of good quality. This occurs because the difference value characteristics are not smaller than the threshold value for longer than the predetermined time period. As a result, the evaluation device determines that the specific overlap time period of each signal contains at least a part of the transmission signal. This signal section can therefore be further examined or processed, for example to determine the position of the object.

FIG. 9 shows a flow chart for determining the reflected transmission signal in the received signals 6, 8, 11. In a first step V1, the transmitter 2 sends out the transmission signal, which is reflected by an object 4. Alternatively, the transmission signal is received directly and is therefore not reflected by an object 4. The three receivers 5, 7, 10 receive the signals 6, 8, 11, which contain at least part of the transmission signal. In addition, the evaluation device is informed of a time range in which the transmission signal is contained.

In a second step V2, the received signals are divided into signal sections and their curve function is determined in each case. In addition, the signal points are determined in the signal sections of the signals.

In a third step V3, a time difference and/or phase angle difference between signal point pairs, containing signal points of the first signal and signal points of the second signal, is determined. This is repeated for signal points of the first signal and signal points of the third signal and for signal points of the second signal and signal points of the third signal. As a result, the offset characteristic values of the offset characteristic curves 14, 17, 18 shown in FIG. 7 are obtained.

In a fourth step V4, groups are formed for each of the offset characteristic curves or offset characteristic values which have several offset characteristic values. In each group, the maximum and minimum values of the offset characteristic value are determined and the difference between the maximum and minimum values is determined. Alternatively or additionally, a variance of the offset characteristic values is determined for each group. This means that there is at least one variance value for each of the groups.

In a fifth step, a time period is determined based on the offset characteristic values, a further time period based on the further offset characteristic values and another time period based on the other offset characteristic values, in which the determined difference values and/or variance values are below the threshold value 22. In addition, it is determined whether the difference values and/or variance values for a predetermined time period are below the threshold value, in particular no longer than the predetermined time period. The predetermined time period can be the time period of the control signal transmitted to the transmitter. In addition, the evaluation device 9 can check whether the overlap section 25 is longer than a predetermined lower time period.

In the case that the conditions are met, the evaluation device 9 evaluates the overlap section 25 as relevant in a sixth step V6. In particular, it is determined that in the overlap time period 25 the quality of the received signals is of sufficient quality for further processing.

The overlap time period 25 can correspond to the time range or be smaller than the time range. If the overlap time period is smaller than the time range, the evaluation device 9 determines that the received signal does not contain the transmission signal in the entire time range or that the quality of the transmission signal in the received signal is not sufficiently high in the entire time range.

The remaining signal sections of the first, second and third signals which do not meet the above conditions are evaluated as irrelevant. This means that during possible signal processing, for example to determine a three-dimensional position of the object 2, the remaining signal sections are not used. If no such overlap period 25 can be determined, it is determined in a seventh step V7 that the transmitted signals 6, 8, 11 are irrelevant.

### LIST OF REFERENCE SYMBOLS

1 Device
2 Transmitter
3 Transmission signal
4 Object
5 First receiver
6 First signal
7 Second receiver
8 Second signal
9 Evaluation device
10 Third receiver
11 Third signal
12 Signal section
13 Further signal section
14 Offset characteristic curve
17 Further offset characteristic curve
18 Other offset characteristic curve
19 First difference value characteristic curve
20 Second difference value characteristic curve
21 Third difference value characteristic curve
22 Threshold value
23 First signal region
24 Second signal region
25 Time period
G1 Group
P1 First signal point
P2 Second signal point
30 P3 Third signal point
V1-V7 Method steps
Z1 Further first signal point
Z2 Further second signal point
Z3 Further third signal point

1-34. (canceled)

35. A method for evaluating multiple received signals, the method comprising:
sending a transmission signal;
receiving a first signal, which contains at least part of the transmission signal, via a first receiver;
receiving a second signal, which contains at least part of the transmission signal, via a second receiver; and
evaluating the received signals, by comparing the received signals with one another, wherein comparing comprises determination of a time difference and/or phase difference between the first signal and the second signal.

36. The method according to claim 35, wherein the received first signal is divided into several signal sections, wherein one or more signal points are determined in the signal section.

37. The method according to claim 36, wherein:
a. a time and/or phase angle assigned to the signal point is determined; and/or
b. multiple signal points are determined, wherein the signal points are arranged offset from one another and/or are arranged offset from a reference point by a predetermined phase angle.

38. The method according to claim 35, wherein the received second signal is divided into several further signal sections.

39. The method according to claim 38, wherein:
a. a curve function of the respective further signal section is determined; and/or
b. the further signal section has the same phase angle range as the signal section.

40. The method according to claim 38, wherein one or more further signal points are determined in the further signal section.

41. The method according to claim 40, wherein:
a. a further time assigned to the further signal point and/or further phase angle is determined; and/or
b. a number of determined further signal points corresponds to a number of determined signal points.

42. The method according to claim 40, wherein
a. multiple further signal points are determined, wherein the further signal points are arranged offset from one another and/or offset from a reference point by a predetermined phase angle; and/or
b. each signal point is assigned a further signal point; and/or
c. the further signal point in the further signal section has the same phase angle as the signal point in the signal section or that the further signal point in the further signal section is arranged offset from the signal point in the signal section by a predetermined phase angle.

43. The method according to claim 35, wherein at least one offset characteristic value is determined which depends on a time difference and/or phase angle difference between the first signal and the second signal.

44. The method according to claim 43, wherein:
a. the offset characteristic value is determined by determining a time difference and/or a phase angle difference from a pair of signal points; and/or
b. the time difference for at least one signal point pair corresponds to a difference between a time assigned to the signal point and the further time assigned to the further signal point; and/or
c. the phase angle difference for at least one signal point pair corresponds to a difference between a phase angle assigned to the signal point and the further phase angle assigned to the further signal point; and/or
d. the time difference and/or phase angle difference is determined by several pairs of signal points, wherein a first signal point of the first signal is adjacent to a second signal point of the first signal and/or a first further signal point of the second signal is adjacent to a second further signal point of the second signal; and/or
e. it is checked whether the at least one offset characteristic value lies within a predetermined range.

45. The method according to claim 35, wherein several offset characteristic values are determined, wherein groups which have several offset characteristic values are formed, and for each group a variance of the offset characteristic values is determined and/or the difference between a maximum value of the offset characteristic value and a minimum value of the offset characteristic value is formed.

46. The method according to claim 45, wherein:
a. it is checked whether the difference values and/or variance values are below a predetermined threshold value; and/or
b. it is checked whether a time period in which the difference values and/or variance values are below a predetermined threshold value is longer than a predetermined time period; and/or
c. a time period is determined in which the difference values and/or the variance values are below a predetermined threshold value for a maximum of a predetermined time period; and/or
d. the evaluation of the received signals depends on the at least one difference value and/or at least one variance value and a predetermined threshold value.

47. The method according to claim 35, wherein a third signal, which contains at least part of the transmission signal and is time-offset from the first signal and the second signal, is received via a third receiver.

48. The method according to claim 47, wherein at least one further offset characteristic value is formed, which depends on a time difference between the first signal and the third signal, and at least one other offset characteristic value is formed, which depends on a time difference between the second signal (8) and the third signal.

49. The method according to claim 48, wherein:
a. several further offset characteristic values are determined, wherein groups are formed which have several further offset characteristic values, and for each group a variance of the several further offset characteristic values is determined and/or the difference between a maximum value of the further offset characteristic value and a minimum value of the further offset characteristic value is formed; and/or
b. several other offset characteristic values are determined, wherein groups are formed which have several other offset characteristic values, and for each group a variance of the several further offset characteristic values is determined and/or the difference between a maximum value of the other offset characteristic value and a minimum value of the other offset characteristic value is formed.

50. The method according to claim 49, wherein:
a. a further time period is determined in which the difference values and/or variance values are below a predetermined threshold value; and/or
b. another time period is determined in which the difference values and/or variance values are below the predetermined threshold value.

51. The method according to claim 50, wherein an overlap time period is determined, in which the time period overlaps with the further time period and/or the other time period, wherein:
a. a signal section of the received signal located in the overlap time period is used to determine a position of an object and/or to determine a distance between the object and a device, and/or
b. the signal sections of the received signal located in the overlap time period are to determine the position of an object and/or to determine the distance between the object and a device.

52. The method according to claim 35, wherein:
a. a time range of the received signals is predetermined, for which the evaluation is carried out; and/or
b. a signal section of the first signal and a further signal section of the second signal, which are compared to evaluate the received signals, have the same phase angle range.

53. A device comprising:
at least one transmitter for sending a transmission signal;
a first receiver for receiving a first signal which contains at least part of the transmission signal;
a second receiver for receiving a second signal which contains at least part of the transmission signal; and
an evaluation device which compares the received signals with one another to evaluate the received signals, wherein comparing comprises determination of a time difference and/or phase difference between the first signal and the second signal.

54. The device according to claim 53, wherein:
a. the device has a third receiver for receiving a third signal which contains at least part of the transmission signal; and/or
b. a distance between the receivers is at most half a wavelength of the received signal and/or the maximum frequency of the transmitted signal or the received signal; and/or
c. the transmitter is configured such that the transmission signal is a sound wave or an electro-magnetic wave.
